(19) United States
(12) Patent Application Publication
(10) Pub. No.: US 2019/0259554 A1
(43) Pub. Date: Aug. 22, 2019

(54) High-Voltage Switching Device and Switching System Comprising a High-Voltage Switching Device and Method for Manufacturing a High-Voltage Switching Device

(71) Applicant: Rail Power Systems GmbH, München (DE)

(72) Inventor: Edenilson De Oliveira Hillmann, Bottrop (DE)

(21) Appl. No.: 16/333,636

(22) PCT Filed: Sep. 18, 2017
(86) PCT No.: PCT/EP2017/073522

§ 371 Date: Mar. 15, 2019

(30) Foreign Application Priority Data
Sep. 20, 2016 (EP) 16189608.9

(51) Int. Cl. H01H 33/662

(52) U.S. Cl. CPC H01H 33/66207; H01H 2229/044; H01H 2033/66223; H01H 2033/6623

(57) ABSTRACT

The invention relates to a high-voltage switching device comprising a vacuum chamber and to a switching system comprising a high-voltage switching device. The invention further relates to a method for manufacturing a high-voltage switching device comprising a vacuum chamber. The high-voltage switching device has a cast housing 1 consisting of a casting resin, which encloses the housing body 3 of the vacuum chamber 2, which has a fixed contact 4A and a movable contact 5A, an intermediate layer 3A being provided between the inner wall of the cast housing 1 and the outer wall of the housing body 3 of the vacuum chamber 2. The high-voltage switching device is distinguished in that this intermediate layer is a casting resin layer 3A, the glass transition temperature of the casting resin layer being between 10 and 40° C. In a construction of this type, no tears in the coating or casing of the housing body of the vacuum chamber and no external flashovers on the housing body have been found in tests.

The invention relates to a high-voltage switching device comprising a vacuum chamber and to a switching system comprising a high-voltage switching device. The invention further relates to a method for manufacturing a high-voltage switching device comprising a vacuum chamber.

In networks of electric power lines, switching systems are used by means of which the electrical power is distributed. Switching systems have switching devices which establish or break an electrically conductive connection between electric contacts. In high-voltage or medium-voltage networks, high-voltage switching devices are used which meet the electrical requirements on the high voltages in high-voltage or medium-voltage networks. The voltages of high-voltage networks are generally between 60 and 52 kV and those of medium-voltage networks are generally between 1 kV and 52 kV.

High-voltage switching devices are known which have a vacuum chamber in which the electric contacts are arranged. However, switching devices are also known in which the electric contacts are located in a gaseous atmosphere of insulating gas, for example SF₆. The use of vacuum chambers has the advantage over chambers filled with insulating gas that load currents and short-circuit currents can be interrupted in a relatively small volume without there being a risk of hot switching gases being emitted. In air-insulated switching devices, a particularly long insulation distance is required, meaning that these switching devices take up a particularly large amount of space. Vacuum chambers are used in switching devices comprising power switches, earthing switches, disconnect switches or load-break switches.

Switching devices comprising a vacuum chamber are known for example from DE 31 12 776 A1 and DE 40 27 723 A1. The known vacuum chambers comprise a housing body in which a stationary switch contact and a movable switch contact are arranged. The movable switch contact is actuated by an actuation unit. The actuation unit can be driven using an electrical drive unit. To reduce the installation size of the high-voltage switching devices and thus of the switching systems having the switching devices, the vacuum chamber is introduced into a casting mould and cast using a casting compound, for example epoxy resin, in such a way that the vacuum chamber is enclosed by a solid cast housing after the casting compound is cured.

If current flows through the high-voltage switching device during operation, the lost power is released in the form of heat. As a result of the heat, the components of the housing body of the vacuum chamber, which may consist of ceramic or metal materials, for example copper, expand more than the solid cast housing. As a result, mechanical stresses and accompanying fine tears may occur in the solid plastics material cast. The service life of the switching device can thus be greatly reduced. Moreover, unexpected flashovers may occur.

For this reason, in the prior art, vacuum chambers in high-voltage switching devices are provided with an outer silicone layer or welded with a heat-shrink tube. The coating of silicone or the use of a heat-shrink tube is intended not only to prevent the occurrence of mechanical voltages, but also to have the advantage that a sufficient insulation distance is produced between the fixed and the movable switching contact along the outer face of the vacuum chamber. External flashovers across the vacuum chamber should thus be prevented.

In practice, it has been found that the coating of the vacuum chamber is a critical element of the switching device in particular at higher voltages, for example voltages of at least 20 kV against earth or at least 36 kV phase-to-phase voltage. Tests have shown that, even in vacuum chambers coated with silicone, flashovers can occur between the silicone coating and the vacuum chamber.

An object of the invention is therefore to reduce the risk of flashovers in high-voltage switching devices and switching systems comprising high-voltage switching devices. A further object of the invention is to set out a method by which a high-voltage switching device having improved electrical properties can be manufactured.

These objects are achieved according to the invention by the features of the independent claims. The dependent claims relate to preferred embodiments of the invention.

Comprehensive tests on various high-voltage switching devices have found insufficient adhesion of the silicone layer to the housing body of the vacuum chamber. It has been found that the insufficient adhesion is responsible for the occurrence of flashovers between the fixed and movable switch contact along the housing body of the vacuum chamber between the silicone layer and the housing body.

The high-voltage switching device according to the invention has a cast housing consisting of a casting resin, which encloses the housing body of the vacuum chamber, which has a fixed contact, which may be a switching contact or disconnect contact, and a movable contact, which may be a switching contact or disconnect contact, an intermediate layer being provided between the inner wall of the cast housing and the outer wall of the housing body of the vacuum chamber. The high-voltage switching device is distinguished in that this intermediate layer is a casting resin layer, the glass transition temperature of the casting resin layer being between 10 and 40° C. Preferably, the glass transition temperature of the casting resin layer is between 20 and 30° C. The glass transition temperature gives an indication as to the dimensional stability of the plastics material under the action of heat. It specifies the temperature at which a plastics material transitions from a liquid or rubbery-elastic, flexible state into a glassy or hard-elastic, brittle state. The coating or casing of the vacuum chamber has a greater flexibility than the solid cast housing of the switching device. In a construction of this type, no tears in the coating or casing of the housing body have been found in tests.

Further, as a result of the good adhesion of the intermediate layer to the vacuum chamber, flashovers between the fixed and the movable switching contact along the vacuum chamber were prevented.

A preferred embodiment provides that the modulus of elasticity of the casting resin of the casting resin layer of the vacuum chamber is less than 1000 MPa. Preferably, the modulus of elasticity of the casting resin layer is greater than 100 MPa, particularly preferably greater than 500 MPa. A casting resin layer having a tensile strength less than 20 MPa has been found to be particularly advantageous. The casting resin is preferably an epoxy resin.

In a particularly preferred embodiment, the high-voltage switching device comprises a plastics material body which is enclosed by the cast housing. An actuation unit for the movable contact of the vacuum chamber is arranged in the plastics material body. The housing body of the vacuum chamber is preferably arranged in an upper housing half in the installed position of the switching device, and the plastics material body is arranged in a lower housing half of the cast housing.

The plastics material body may consist of one or more plastics material elements which are interconnected. Advantageously, the plastics material body consists of a plurality of plastics material elements, which can be manufactured in a simple, cost-effective manner by injection moulding and subsequently interconnected. Individual plastics material elements can be plugged together and/or glued or welded together. With the use of a plastics material body, not only can the electrical properties of the switching device be improved, but the manufacture thereof can also be simplified.

In a high-voltage switching device in which a plastics material body of this type is used, the intermediate layer makes possible reliable sealing-off of the vacuum chamber from the plastics material body, and this is advantageous for the manufacture of the high-voltage switching device since, during injection moulding, casting resin cannot enter a gap between the vacuum chamber and the plastics material body.

For reliable sealing, in a particularly preferred embodiment, the plastics material body has, on an upper face, projections or cutting edges which are cut into the flexible casting resin layer on the lower face of the vacuum chamber.

The switching system according to the invention has one or more switching devices according to the invention.

The method according to the invention for manufacturing the high-voltage switching device according to the invention provides that the surface of the housing body of the vacuum chamber is machined to increase the surface roughness before a casting resin layer is applied to the outer wall of the housing body of the vacuum chamber. The surface of the housing body is preferably machined in such a way that the surface roughness is greater than 20 μm, preferably between 20 μm and 40 μm. This provides optimal adhesion between the casting resin and the housing body. Machining the surface of the housing body of the vacuum chamber using glass beads has been found to be particularly advantageous. The surface of the housing body should also be degreased.

The casting resin layer may be applied to the housing body of the vacuum chamber by the method known in the art. Preferably, the casting resin layer is applied by pressure gelation or vacuum application, making it possible to avoid the formation of air bubbles.

After the casting resin layer is applied to the outer wall of the housing body of the vacuum chamber, the surface of the casting resin layer is machined so as to achieve optimal adhesion to the cast housing. The surface of the casting resin layer is preferably machined in such a way that the surface roughness is greater than 90 μm, preferably between 90 μm and 120 μm. It has been found to be particularly advantageous to machine the surface of the casting resin layer by corundum blasting. A blasting method of this type is part of the prior art. The surface of the casting resin layer should also be degreased. Subsequently, the vacuum chamber is introduced into a casting mould. For manufacturing the high-voltage switching device, a casting mould may be provided which corresponds in shape and dimensions to the outline of the cast housing of the switching device. The plastics material body may also be introduced into the casting mould. Thereupon, the space between the inner wall of the casting mould and the outer wall of the vacuum chamber is cast using a casting resin. This produces the cast housing. A cavity for installing the actuation unit for the movable switching contact may be provided in the plastics material body. Finally, yet further modules or components of the high-voltage switching device, for example the actuation unit or conductor parts to be connected to the fixed and the movable switching contact, may be introduced into the casting body or the plastics material body.

Hereinafter, an embodiment of the invention is described in greater detail, referring to the drawings, in which:

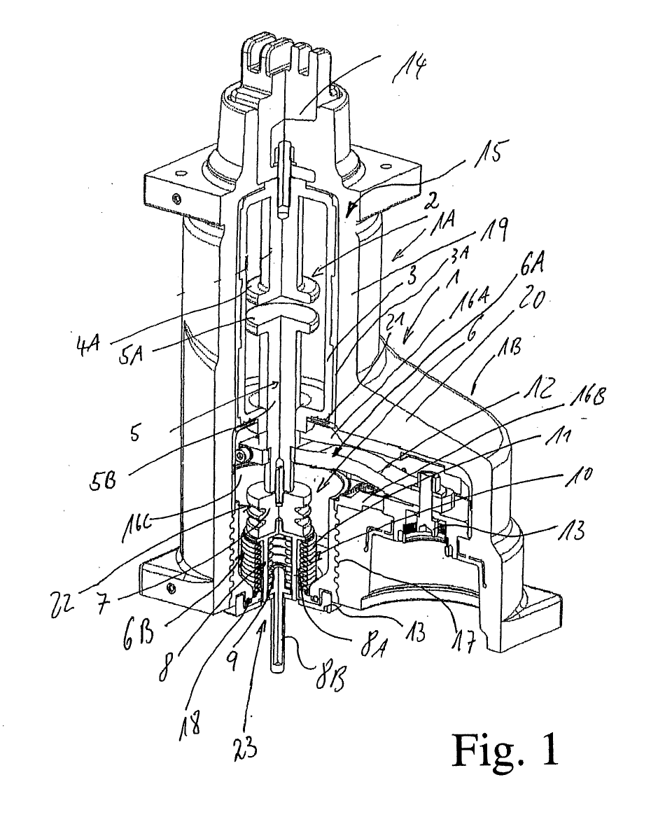

FIG. 1 is a partially sectional perspective drawing of an embodiment of the high-voltage switching device according to the invention,

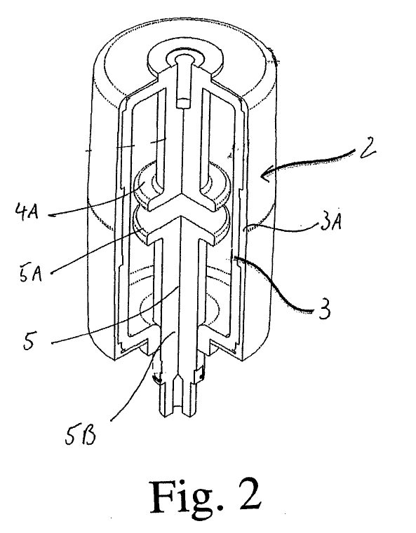

FIG. 2 is a partially sectional perspective drawing of the vacuum chamber of the high-voltage switching device according to the invention, and

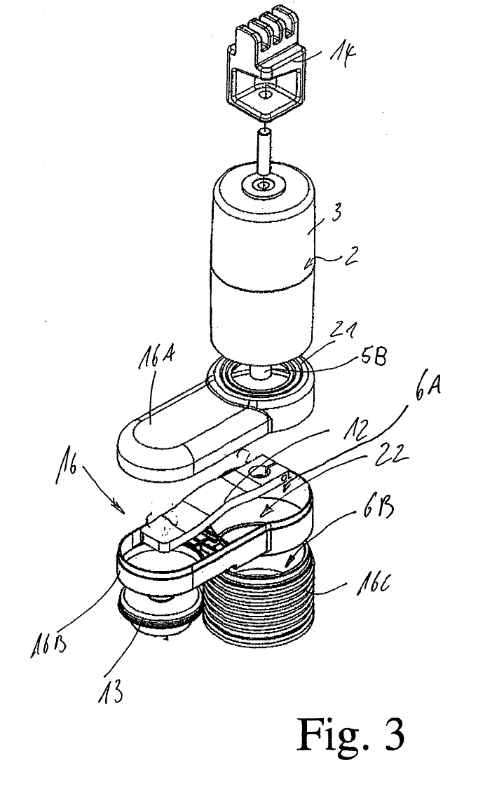

FIG. 3 is an exploded drawing of further components of the high-voltage switching device according to the invention.

FIG. 1 shows the components essential to the invention of the high-voltage switching device, whilst FIG. 2 shows the vacuum chamber of the switching device. The mutually corresponding parts are provided with like reference numerals in the drawings. The vacuum chamber may for example be a vacuum switching chamber for switching load currents or short-circuit currents in a power switch or a vacuum disconnect chamber for a disconnect switch or earthing switch or combined switch. Hereinafter, the invention is described with reference to a power switch.

The high-voltage switching device has a cast housing 1, which has an upper housing half 1A and a lower housing half 1B in the normal installed position. In the upper housing half 1A, there is a vacuum chamber 2 having a cylindrical housing body 3 which accommodates an upper, fixed switching contact 4A and a lower, movable switching contact 5B. The housing body 3 of the vacuum chamber 2 may consist of a plurality of components made of metal or ceramic materials. By closing or opening the contacts 4A, 5A, the current path can be closed or interrupted, in other words for example a load current can be switched. In the lower housing half 1B, there is a plastics material body 16, in which a chamber 6 is formed in which an actuation unit for the movable switch contact is arranged. The chamber 6 is filled with an insulating liquid. The actuation unit is described in greater detail below.

The cast housing 1, produced by injection moulding, of the high-voltage switching device may consist of a conventional casting resin. Preferably, the cast housing consists of epoxy resin. The casting resin has a glass transition temperature (Tg) between 80 and 120° C. The maximum tensile stress of the casting resin (tensile strength) is greater than 60 MPa, and the elongation at break of the casting resin (tensile strength) is less than 3%. The modulus of elasticity (elastic modulus) of the casting resin is greater than 8000 MPa. The cast housing is a solid housing body.

In the space between the outer wall of the vacuum chamber 2 and the inner wall of the solid cast housing 1, there is an intermediate layer 3A consisting of a casting resin which is more flexible than the casting resin of the cast housing 1.

The flexible casting resin has a glass transition temperature (Tg) between 10 and 40° C. The maximum tensile stress (tensile strength) of the casting resin is less than 20 MPa and the elongation at break (tensile strength) is greater than 9%. The modulus of elasticity (elasticity modulus) of the casting resin is less than 1000 MPa. Preferably, the modulus of elasticity of the casting resin is greater than 100 MPa, particularly preferably greater than 500 MPa, in particular approximately 600 MPa. As a casting resin, the material known by the name Araldite® (Huntsman Advanced Materials), in particular Araldite® S-HCEP or Araldite® CW 1491/HW 1491, has been found to be particularly advantageous.

For manufacturing the high-voltage switching device, a layer of the aforementioned material is applied to the housing body 3 of the vacuum chamber 2. The casting resin layer 3A can be applied by methods known in the art. FIG. 2 shows the housing body 3 of the vacuum chamber 2 along with the outer casting resin layer 3A, which extends over the cylindrical peripheral surface and over the upper and lower face, in the installed position, of the housing body of the vacuum chamber.

Hereinafter, the actuation unit for the movable switching contact and further modules and components of the high-voltage switching device are described in detail, referring to FIGS. 1 to 3.

The switching contact 5A, which is displaceable in the axial direction of the vacuum chamber 2, is a component of a switching contact element 5, which has a shaft 5B which extends out of the vacuum chamber 2 into the chamber 6 filled with insulating liquid. The shaft 5B of the movable switching contact element 5 is sealed off from the housing body 3 of the vacuum chamber 2 in a vacuum-tight manner by a sealing arrangement (not shown). The lower end of the shaft 5B is connected via an insulating body 7 to an actuation member 8, which extends out of the liquid-filled chamber 6. By actuating the actuation member 8, the movable switching contact element 5 can be axially displaced, in such a way that the contacts 4A, 5A are closed or opened.

The actuation member 8 has an upper, hollow cylindrical sub-piece 8A, which is located in the chamber 6, and a lower, pin-shaped sub-piece 8B, which is guided longitudinally displaceably in the cylinder space of the upper sub-piece and extends out of the chamber 6. In this context, the upper end piece of the lower sub-piece 8B is braced against a compression spring 9 in the cylinder space of the upper sub-piece 8A. When the lower sub-piece 8B is displaced, the upper sub-piece 8A is also displaced, in such a way that the movable switching contact element 5 is axially displaced. The compression spring 9 is for damping the impacts when the actuation member 8 is actuated. The actuation member 8 is driven by a drive unit (not shown), which displaces the lower sub-piece 8B in an axial direction.

The actuation member 8 is sealed off from the cast housing 1 in a liquid-tight manner by a sealing arrangement 10. The sealing arrangement 10 has a bellows 11, which encloses the upper sub-piece 8A of the actuation member 8, the upper end of the bellows 11 being connected to the upper sub-piece 8A of the actuation member 8 in a liquid-tight manner. The lower end of the bellows 11 is sealed off from the cast housing 1 in a liquid-tight manner. The bellows 11 and the actuation member 8 are connected to earth potential. On the lower face, the housing body 1 has an opening 12, which is sealed in a liquid-tight manner by a cover 13.

The liquid-filled chamber 6 has an upper and lower chamber half 6A, 6B in the installed position. In the upper chamber half 6A there is a movable conductor part 12, for example a copper strip, which is connected to the shaft 5B of the movable switching contact element 5. The movable conductor part 12 is electrically connected to further conductor parts 13 (only shown in part) which form the current path. The fixed switching contact element 4 is connected to further conductor parts 14 (only shown in part), which are likewise introduced into the cast housing 1 or placed on the cast housing.

The plastics material body 16 in the lower housing half 1B of the cast housing 1 is composed of a plurality of plastics material elements 16A, 16B, 16C. FIG. 3 is an exploded drawing of the plastics material elements 16A, 16B, 16C. The plastics material body 16 has in the upper chamber half 6A an upper shell-shaped plastics material element 16A and a lower shell-shaped plastics material element 16B, which enclose the movable conductor part 12, and has in the lower chamber half 6B a cylindrical plastics material element 16C, which encloses the bellows 11. The plastics material elements 16A, 16B, 16C are formed in such a way that they can be assembled conveniently. They are tightly plugged together and/or glued or welded together. All of the plastics material elements 16A, 16B, 16C have rounded corners or edges.

The two plastics material elements 16A, 16B in the upper chamber half 6A consist of an electrically conductive plastics material; for example, conductive carbon may be added to the plastics material. Since these plastics material elements 16A, 16B can take on the same potential as the movable conductor part 12 or other conductor parts in the chamber, the electrical field is more homogeneous externally.

The plastics material element 16C in the lower chamber half 6B, which does not consist of a conductive plastics material, cannot carry any potential. This plastics material element 6C provides reliable insulation of voltage-carrying parts in the chamber 6 from the actuation member 8 connected to earth potential. To increase the creepage distance, the plastics material element 16C has lamellae 17 on the outer face.

The cover 13 of the cast housing 1, which seals the liquid-filled chamber 6, is sealed off from the cylindrical plastics material part 16C in a liquid-tight manner using a sealing ring 18 positioned between the cover and the plastics material part.

Hereinafter, the method according to the invention for manufacturing the high-voltage switching device is described.

The housing body 1 of the vacuum chamber 2 is provided with the above-described flexible casting resin layer 3A. For this purpose, the surface of the housing body 3 is initially machined so as to achieve optimal adhesion to the housing body 2. The surface is for example blasted with glass beads, in such a way that the surface roughness is greater than 20 μm, preferably between 20 μm and 40 μm, and the surface is degreased.

Subsequently, the housing body 1 of the vacuum chamber 2 is introduced into a casting mould (not shown), which may consist of two mould halves, and the casting resin is filled into the space between the inner wall of the mould halves and the outer wall of the housing body 3. The housing body 3 may be cased or coated by the known pressure gelation process. The filling pressure should be above 1 bar. Typical values are 3 to 7 bar. In this way, bubble-free casting can be ensured.

After the casting resin cures and the mould halves are removed, the surface of the casting or coating is machined so as to achieve optimal adhesion to the casting resin of the solid cast housing 1. The surface of the casting resin layer is machined in such a way that the surface roughness is greater than 90 μm, preferably between 90 μm and 120 μm. The surface may be machined for example by corundum blasting.

For manufacturing the cast housing 1 of the switching device, a casting mould (not shown in the drawings) is used, which is formed in such a way that it corresponds to the shape and dimensions of the cast housing 1 and to the shape and dimensions of the vacuum chamber 2 provided with the casting resin layer 3A and of the other components switching device. The vacuum chamber 2 is inserted into the upper half of the casting mould, a space 19 being left between the inner wall of the casting mould and the outer wall of the vacuum chamber 2. The plastics material body 16 is introduced into the lower half of the casting mould, a space 20 also being left between the wall of the casting mould and the plastics material body 16. Subsequently, the spaces 19, 20 between the casting mould and the vacuum chamber or plastics material body are cast with a casting material having the above-described material properties.

The upper plastics material element 16A in the upper chamber half 6A has at the upper edge preferably a plurality of annular projections or cutting edges 21, which cut into the coating or casing 3A of the housing body 3 of the vacuum chamber 2 when the components are pressed together, in such a way that the casting compound for the cast housing, which has a relatively high viscosity in the liquid state, cannot penetrate under pressure into a gap between the housing body 3 of the vacuum chamber 2 and the plastics material body 16.

After the casting compound has cured, the movable conductor part 12, the actuation member 8, the insulation body 7 and the switching arrangement 10, and optionally further components of the switching device are introduced into the cavity enclosed by the plastics material body 16, and the cavity is filled with the insulating liquid. Thereupon, the cavity is sealed in a liquid-tight manner by placing the cover 13 on.

1. High-voltage switching device comprising a cast housing (1) consisting of a casting resin, which encloses a vacuum chamber (2), which has a housing body (3) in which a fixed contact (4A) and a movable contact (5A) are arranged, an intermediate layer (3A) being provided between the inner wall of the cast housing (1) and the outer wall of the housing body (3) of the vacuum chamber (2),
characterised in that
the intermediate layer (3A) is a casting resin layer, the glass transition temperature of the casting resin layer being between 10 and 40° C.

2. High-voltage switching device according to claim 1, characterised in that the glass transition temperature of the casting resin layer (3A) is between 20 and 30° C.

3. High-voltage switching device according to either claim 1 or claim 2, characterised in that the modulus of elasticity of the casting resin layer (3A) is less than 1000 MPa.

4. High-voltage switching device according to any of claims 1 to 3, characterised in that the modulus of elasticity of the casting resin layer (3A) is greater than 100 MPa, preferably greater than 500 MPa.

5. High-voltage switching device according to any of claims 1 to 4, characterised in that the tensile strength of the casting resin layer (3A) is less than 20 MPa.

6. High-voltage switching device according to any of claims 1 to 5, characterised in that the casting resin is an epoxy resin.

7. High-voltage switching device according to any of claims 1 to 6, characterised in that the cast housing (1) encloses a plastics material body (16) in which an actuation unit for the movable contact is arranged, the housing body (3) of the vacuum chamber (2) being arranged in an upper housing half (1A) in the installed position of the switching device and the plastics material body (16) being arranged in a lower housing half (1B) of the cast housing (1), and the plastics material body (16) having, on the upper face, projections or cutting edges (21) which are cut into the casting resin layer (3A) on the lower face of the plastics material body.

8. Switching system comprising a high-voltage switching device according to any of claims 1 to 7.

9. Method for manufacturing a high-voltage switching device according to claim 1, characterised in that the method has the following method steps:
machining the surface of the housing body (3) of the vacuum chamber to increase the surface roughness,
applying a casting resin layer (3A) to the outer wall of the housing body (3) of the vacuum chamber (2),
machining the surface of the casting resin layer (3A) to increase the surface roughness,
introducing the vacuum chamber (2) into a casting mould,
casting the space between the inner wall of the casting mould and the outer wall of the vacuum chamber (2) with a casting resin having a glass transition temperature of between 10 and 40° C.

10. Method according to claim 9, characterised in that a casting resin layer (3A), having a glass transition temperature between 10 and 40° C., is applied to the outer wall of the housing body (3) of the vacuum chamber (2).

11. Method according to either claim 9 or claim 10, characterised in that a casting resin layer (3A) having a modulus of elasticity less than 1000 MPa is applied to the outer wall of the housing body (3) of the vacuum chamber (2).

12. Method according to any of claims 9 to 11, characterised in that a casting resin layer having a modulus of elasticity greater than 100 MPa, preferably greater than 500 MPa, is applied to the outer wall of the housing body (3) of the vacuum chamber (2).

13. Method according to any of claims 9 to 12, characterised in that a casting resin layer (3A) having a tensile strength less than 20 MPa is applied to the outer wall of the housing body (3) of the vacuum chamber (2).

14. Method according to any of claims 9 to 13, characterised in that a casting resin layer (3A) consisting of epoxy resin is applied to the outer wall of the housing body (3) of the housing chamber (2).

15. Method according to any of claims 9 to 14, characterised in that the casting resin layer (3A) is applied to the housing body (3) of the vacuum chamber (2) by a pressure gelation process.

16. Method according to any of claims 9 to 15, characterised in that the surface of the housing body (3) of the vacuum chamber (2) is machined in such a way that the surface roughness is greater than 20 μm, preferably between 20 μm and 40 μm, and/or the surface of the casting resin layer (3A) is machined in such a way that the surface roughness is greater than 90 μm, preferably between 90 μm and 120 μm.
